(19) United States
(12) Patent Application Publication
(10) Pub. No.: US 2008/0136214 A1
(43) Pub. Date: Jun. 12, 2008

(54) Multiple Roof Configurations For a Single Vehicle Platform

(75) Inventors: Albert W. Harrison III, Detroit, MI (US); John Thomas, Rochester Hills, MI (US)

Correspondence Address: BRINKS HOFER GILSON & LIONE, P.O. BOX 10395, CHICAGO, IL, 60610, US

(73) Assignee: COLLINS & AIKMAN PRODUCTS CO., Troy, MI (US)

(21) Appl. No.: 10/596,592

(22) PCT Filed: Dec. 12, 2003
(86) PCT No.: PCT/US2003/040137

§ 371 Date: Dec. 5, 2007

Related U.S. Application Data
(60) Provisional application No. 60/433,132, filed on Dec. 13, 2002.

(51) Int. Cl. B60J 7/12

(52) U.S. Cl. 296/107.17

(57) ABSTRACT

An apparatus for use in a motor vehicle having a roof system, the motor vehicle further having a body with a passenger compartment and a trunk space, the apparatus comprising a roof system comprising any one of a rigid panel hardtop, a retractable hardtop moveable from an extended position disposed above the passenger compartment to a retracted position, or a soft convertible top movable from an extended position disposed above the passenger compartment to a retracted position, wherein any one of the rigid panel hardtop, retractable hardtop or convertible soft top includes an attachment bracket. A transverse support beam having a first end and a second end is included, the support beam carrying any one of the rigid panel top, the retractable hardtop or the soft convertible top, wherein the first end and said second end include universal adapter brackets. The universal adapter brackets are connected to the attachment brackets and to the vehicle body.

### CROSS-REFERENCE TO RELATED APPLICATIONS

This application claims the benefit of U.S. provisional application Ser. No. 60/433,132, filed Dec. 13, 2003, the entire disclosure of which is incorporated herein by reference.

### FIELD OF THE INVENTION

This invention is directed at roof systems for motor vehicles wherein the use of a universal adapter structure allows the option of installing a rigid hardtop roof, a retractable hardtop roof or a fabric soft top convertible roof configuration into a single motor vehicle platform as part of an on-line assembly process. In addition, a transverse support beam is provided which may serve as a sub-component build-up structure, a handling and dunnage support and as a connecting means to the universal adapter structure to accurately and reliably locate any of the vehicle roof systems.

### BACKGROUND OF THE INVENTION

While rigid hardtops comprise the roof system for most motor vehicles, there is a continuing demand for retractable tops, both soft and hard, for sportier “convertible” versions. Generally, the annual volume requirements for convertibles are low and the structural requirements are different enough from the standard rigid hardtop model that a special off-line or modular production facility is employed for build-up and assembly of convertible options. Different attachment points for the various types of roofs are usually required as well as hinging mechanisms for folding the convertible top. A portion of the trunk of the vehicle is usually employed to store the retracted top in its collapsed form.

Roof systems for most vehicles are rigid metal sections, which are welded in place and provide a portion of the structural integrity of the vehicle. It is also common in the automobile industry to employ fabric soft top convertible roofs or retractable hardtop convertible roofs, which are movable from an extended position above a passenger compartment to a retracted position near the vehicle trunk. The traditional retractable hardtop roof system employs a plurality of rigid roof panels, which can slide or be hinged and retracted for storage into the rear passenger compartment or trunk of the vehicle. A more popular convertible roof system comprises a fabric-covered frame, which can fold and retract in a like manner taking up much less space in the vehicle.

However, to accommodate both rigid hardtop as well convertible soft top or retractable hardtop versions on a vehicle platform, separate coupe and convertible (open roof) bodies must be provided to the assembly plant. Each of these roof systems has its own attachment points, structural requirements and assembly details which does not allow the use of a single vehicle platform body-in-white to accommodate all three options.

In order to reduce the cost of off-line assembly of these lower volume options, it is desirable to provide a single vehicle platform body-in-white which can accept any of the three roof system options and allow installation of that option as part of a just-in-time or sequenced part delivery demand system on a moving vehicle assembly line.

In this manner, as a customer order for a vehicle is received at the assembly plant and programmed into the daily schedule, the desired roof system can be scheduled to arrive at the installation station to mate up with the vehicle body as part of a sequenced delivery process. Since only a single vehicle platform body-in-white is required, a uniform production rate and normal assembly procedure can be employed regardless of which roof system is to be installed.

There are numerous patents which address convertible soft tops and retractable hardtops for vehicles, however, in each case a body which is specially designed to accommodate only that style of top is required, rather than a universal body adapter structure which would allow a vehicle body to accommodate any of three distinctly different types of roof system as provided by the present invention. U.S. Pat. Nos. 6,390,532 B1 and 6,422,637 B1 are directed at retractable hardtops for motor vehicles and are assigned to the assignee of the present invention and are included herein by reference.

It is an object of the present invention to provide a universal adapter structure that allows the installation of a rigid hardtop roof, a retractable hardtop roof or a soft fabric retractable convertible roof into a single vehicle platform body-in-white on a moving assembly line.

It is a further object of this invention to provide a system of accurate and repeatable location and attachment points for all three of the roof systems using a spider gage.

It is further object of this invention to provide a cross-car structure for assembly, transporting and installation of the vehicle roof system into the vehicle body. This structure may also provide a location for the power unit which drives the activation of the convertible top.

It is a still further object of the present invention to provide a rear deck lid capable of being hinged at both the front and the rear such that the convertible top may be easily stored, in addition to allowing normal access to the trunk from the rear of the vehicle.

It is a still further object of the present invention to provide a vehicle body-in-white which is designed to accept the worst case structural stress and strain caused by any one of the convertible roof system options.

It is a still further object of the present invention to provide a roof header structure that permits latching of either the hardtop or soft top convertible roof system as well as permanent fastening of the rigid hard top roof system.

These and further objects, features and advantages of the present invention will become apparent from the following description when taken in connection with the accompanying drawings which, for purposes of illustration only, show several embodiments in accordance with the present invention.

### SUMMARY OF THE INVENTION

In a first embodiment, the present invention is directed at an apparatus for use in a motor vehicle having a roof system, said motor vehicle further having a body with a passenger compartment and a trunk space, said apparatus comprising a roof system comprising any one of a rigid panel hardtop, a retractable hardtop moveable from an extended position disposed above said passenger compartment to a retracted position, or a soft convertible top movable from an extended position disposed above said passenger compartment to a retracted position, wherein any one of said rigid panel hardtop, retractable hardtop or convertible soft top includes an attachment bracket. A transverse support beam is supplied having a first end and a second end, said support beam carrying any one of said rigid panel top, said retractable hardtop or said soft convertible top, wherein said first end and said second end include universal adapter brackets. The universal adapter brackets are connected to said attachment brackets and to the vehicle body.

In a second embodiment, the present invention is directed at an apparatus for use in a motor vehicle having a roof system, said motor vehicle further having a body with a passenger compartment and a trunk space, said apparatus comprising a roof system comprising any one of a rigid panel hardtop, a retractable hardtop moveable from an extended position disposed above said passenger compartment to a retracted position, or a soft convertible top movable from an extended position disposed above said passenger compartment to a retracted position, wherein any one of said rigid panel hardtop, retractable hardtop or convertible soft top includes an attachment bracket. A transverse support beam is supplied having a first end and a second end, said support beam carrying any one of said rigid panel top, said retractable hardtop or said soft convertible top, wherein said first end and said second end include universal adapter brackets, and wherein said universal adapter brackets are connected to said attachment brackets.

In a third embodiment the present invention is directed at a motor vehicle having a roof system, said motor vehicle further having a passenger compartment and a trunk space, said motor vehicle comprising a single body capable of accepting a roof system comprising any one of a rigid panel hardtop, a retractable hardtop or a soft convertible top, and a universal adapter brackets attached to said body to locate and attach said any one of said rigid panel hardtop, said retractable hardtop or said soft convertible top roof system.

In a fourth embodiment, the present invention is directed at a motor vehicle roof system for use in an automotive vehicle having a passenger compartment and a storage compartment, said roof system comprising a transverse support beam structure having a first end and a second end, one of (i) a rigid panel roof structure fastened to said vehicle or (ii) a retractable hardtop structure said retractable hardtop structure comprising a series of hingedly or slidably engaged panels, said retractable hardtop being movable between an extended position covering the passenger compartment and a retracted position for storage in said storage compartment, or (iii) a soft convertible top structure comprising a fabric covering and folding mechanism, said soft convertible top being movable between an extended position covering said passenger compartment and a retracted position for storage in said storage compartment, wherein said transverse beam structure connects to one of said rigid panel roof, retractable hardtop or soft convertible top to provide for assembly of one of said rigid panel roof, retractable hardtop or soft convertible top upon said beam. The transverse support structure provides a handling and transport aid for said roof system, and said transverse support provides attachment at said first end and said second end within said vehicle.

### BRIEF DESCRIPTION OF THE DRAWINGS

To better understand and appreciate the invention, refer to the following detailed description in connection with the accompanying drawings.

FIG. 1 is a perspective view of a body-in-white vehicle into which any of the roof systems of the present invention may be installed.

FIG. 1A is a perspective view of the vehicle body of FIG. 1.

FIG. 2 is a side view of a fabric soft top convertible roof system according to the present invention.

FIG. 3 is a side view of a retractable hardtop roof system according to the present invention.

FIG. 4 is a side view of a rigid hardtop roof system according to the present invention.

FIG. 5 is a perspective view of the adapter bracket, which is used as an attachment point for any of the three roof systems of the present invention.

FIG. 5A is a side view of the adapter bracket and spider gage for installing the bracket of the present invention.

FIG. 6 is a perspective view of the spider-gage, which locates and positions the bracket of the present invention.

FIGS. 7, 8 and 9 are side views of the rear deck hinging mechanism, which allows storage of either the retractable or convertible top.

FIGS. 10-12 are perspective views of a rigid roof system being installed into a common vehicle body.

FIGS. 13-15 are perspective views of a retractable hard top being installed into a common vehicle body.

In the appended drawings, common elements use the same numeric character but are distinguished by the addition of a letter to identify a common element between embodiments (for instance 10, 10A, 10B, etc.).

### DESCRIPTION OF PREFERRED EMBODIMENTS

In accordance with the present invention there is provided a novel and improved universal adapter structure that allows the installation of any one of a rigid roof system, a retractable hardtop roof system or a soft top convertible roof system into a single vehicle platform body-in-white. The universal adapter structure comprises a set of metal brackets, which can be positioned by a spider gage which is located by dimensional registration points in the body-in-white structure. The spider gage locates, positions, orients and attaches the universal adapter brackets to the body structure in the vicinity of the vehicle rear wheelwells to coincide with the attachment brackets of the roof system that is targeted for installation into the specific body being assembled. The attachment brackets for each roof system may have unique features that match features in the universal adapter brackets.

To further ensure an accurate fit of the roof system to the body-in-white, the spider gage or an accompanying robot may preferably mill slots and drill holes in the brackets or body structure to ensure that each fit is dimensionally accurate.

The present invention further provides a transverse support structure, which may preferably carry the particular roof system to be installed which has at each end unique attachment brackets and which attaches to the aforementioned adapter structure. The transverse beam structure has the advantage of acting as an assembly base for building up components and sub-components of the roof system, including the power drive unit, that make up the particular roof system to be installed. Later in the process flow, the support may also serve as a handling and transport (dunnage) aid for installation into the vehicle.

In addition, the present invention provides a rear deck lid capable of pivoting around both front and rear edges to allow storage of the retractable or convertible top as well as to allow for normal usage of the trunk area of the vehicle. Further, the present invention provides for latching of the convertible or retractable top as well as fastening of the rigid roof to the roof header structure at the windshield.

The present invention preferably comprises a single common motor vehicle body and, optionally, any one of three roof systems which can be installed according to the schedule on an assembly line by using a universal adapter bracket system and a spider gage. The roof system may be carried on a transverse support, which attaches to the brackets of the universal adapter system and becomes part of the vehicle structure in the area of the rear seat or package tray.

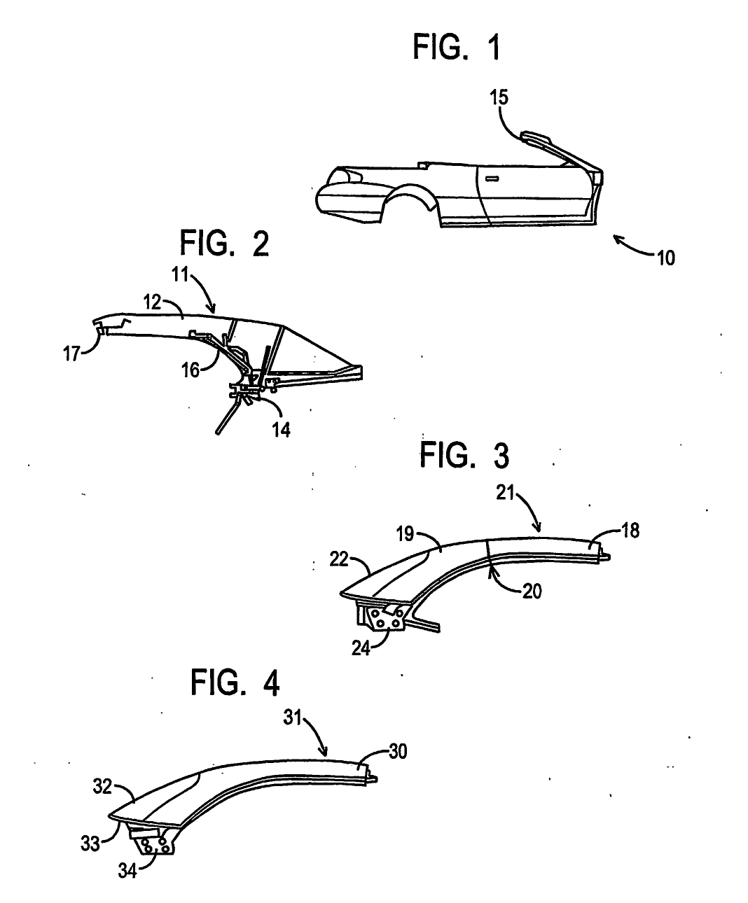

FIG. 1 is a side view of a vehicle body-in-white ready to have a roof system installed according to the present invention. This is the common body construction as provided by the present invention which would be designed and built structurally to accommodate any of a rigid roof system, a retractable hardtop system or a soft convertible top system.

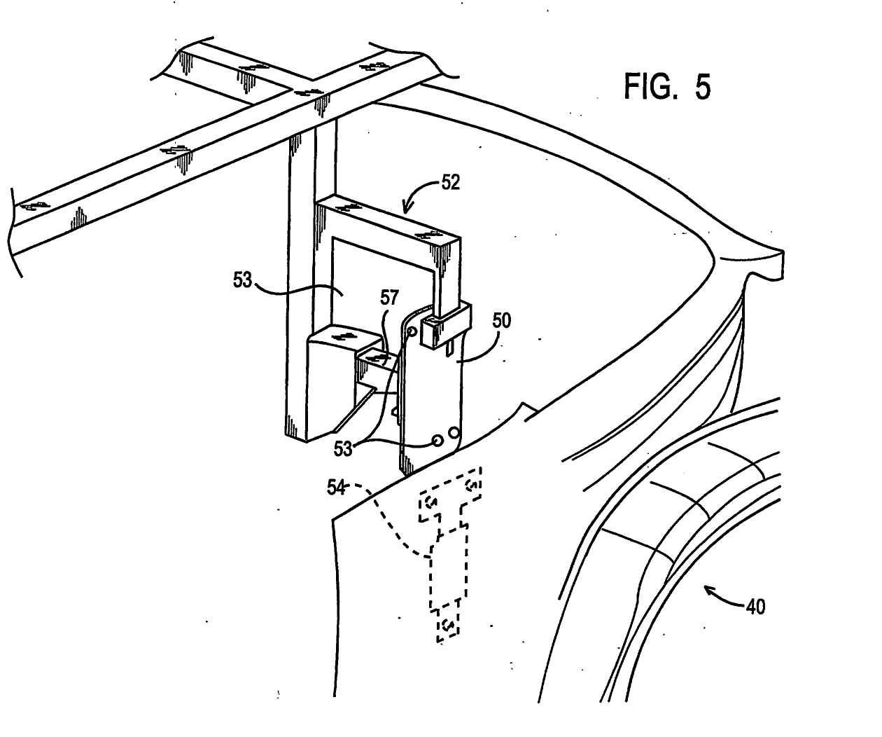

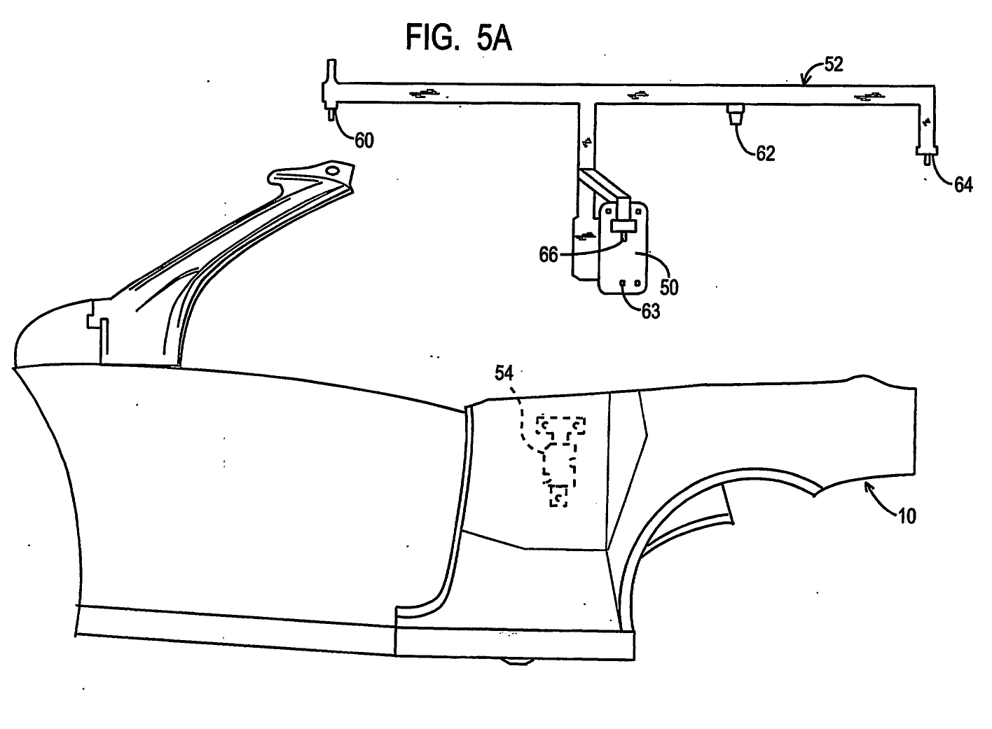

FIG. 2 is a side view of a soft fabric convertible top roof system 11 that may be installed on the body 10 of FIG. 1 according to the present invention. The convertible top is comprised of a foldable fabric covering 12, and a pivot and linkage system 16 which allows the flexible top to fold upon itself and retract into a space behind the rear seat or in the trunk of the vehicle. A fastening system 17 is provided at the front end of the roof system to attach to the windshield header structure (15 in FIG. 1) of the body 10 for securing the roof system 11 in an expanded state which then covers the passenger portion of the vehicle interior. An attachment bracket system 14 is shown which mates to a universal adapter bracket installed into the vehicle body 10 in the proximity of the rear wheel wells (see FIG. 5) to secure the rear of the convertible top to the vehicle body. Typically, the rear attachment brackets 14 on the roof system are connected to the universal adapter brackets by bolts or rivets.

FIG. 3 illustrates a second vehicle roof system, a retractable hardtop roof system 21 which may be optionally installed into the body 10 of FIG. 1. The retractable hardtop comprises a rear window 22 and a rigid panel rearward portion 19 hingedly connected at 20 to a rigid panel forward portion 18. In an extended condition, the top 21 is connected to the body windshield header (15 in FIG. 1) at the front, and at the rear through bracket 24 to the universal adapter bracket of the present invention when installed into the body 10 of the vehicle in the vicinity of the rear wheel wells (see FIG. 5). As shown in FIG. 8 and 9, the retractable hard top can fold around hinge point 20 (FIG. 3) and retract into the trunk of the vehicle by hinging the rear deck lid near its rear edge.

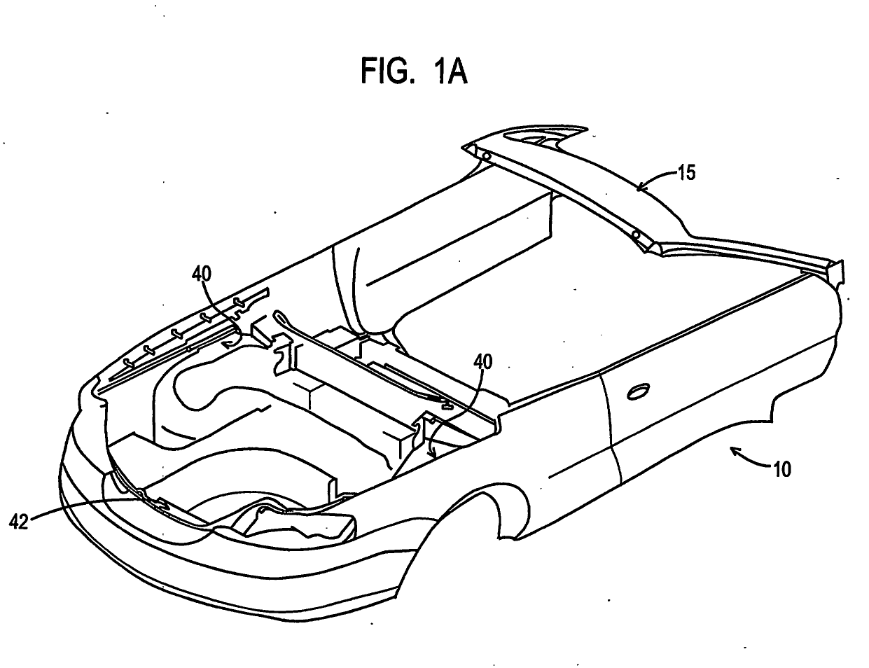

FIG. 4 illustrates the third roof system which may be optionally installed in body 10 of FIG. 1, in this case a rigid roof system 31. The rigid roof system 31 comprises a rigid panel 30 and a rear window 32 which are fastened, usually by welding, at the front edge to the windshield header structure (15 in FIG. 1). The rear of the rigid top is fastened at attachment bracket 34 to a universal adapter bracket installed in the rear wheel well area of the body 10. Optionally, the top may also be welded to the vehicle body along its rear edge 33.

Turning to FIG. 1A, a prospective view of the interior of the vehicle body 10 in FIG. 1 is shown. Here, the windshield header structure is more clearly seen at 15. The proximity for installation of the rear attachment bracket 14, 24 and 34 of FIGS. 2, 3 and 4 for each of the roof system options is shown at 40. As will next be described, a spider gage is preferably employed to accurately locate the universal adapter brackets in the vicinity of 40 on each side of the body 10. This gage engages with body registration points on the windshield header structure 15, on the sides of the body in the proximity of 40 and at the rear of the vehicle in the proximity of 42.

FIG. 5 is a close-up of the body 10 in the area of the rear wheel well 40 and illustrates a universal adapter bracket 50 for installation in the vehicle. The bracket 50 contains a pattern of holes 53, or optionally other features, some of which match up to each of the aforementioned bracket systems (14, 24, 34 of FIGS. 2, 3 and 4 respectively). The adapter bracket 50 is shown mounted on a dimensionally accurate rigid metal spider gage 52 which may position, orient, locate and attach the bracket to the vehicle body at 54 by welding, bolting or otherwise securely fastening. For the three different roof systems of the present invention, the spider gage may install the adapter bracket 50 in any of a number of orientations to accommodate the specific roof system indicated for the specific body number that is being assembled. In that case, fewer locating holes are required since the orientation of the adapter bracket 50 defines which roof system will align with the holes or features in the roof system attachment brackets.

In an optional embodiment, the adapter bracket 50 may contain a larger number of holes and be installed in a single orientation. The bolt holes or features in the respective roof system bracket (14, 24 and 34) would then align with corresponding hole 52, or feature in the adapter bracket 50 for the roof option selected, upon installation of the roof system (11, 21 or 31 of FIGS. 2, 3, and 4) into the vehicle body 10.

A further option is for the spider gage to locate the brackets and a separate robot or person to install the brackets by riveting, bolting or welding to the vehicle body.

FIG. 5A is a side view of the vehicle body 10 illustrating the position of the universal adapter bracket 50 held by the spider gage 52 before installation of the adapter bracket into the vehicle at 54. Also illustrated here are locating features on the spider gage 52 at 60, 62, 64 and 66 for registering the spider gage 52 with the body 10 to assure that the adapter bracket 50 is accurately positioned in the body at 54.

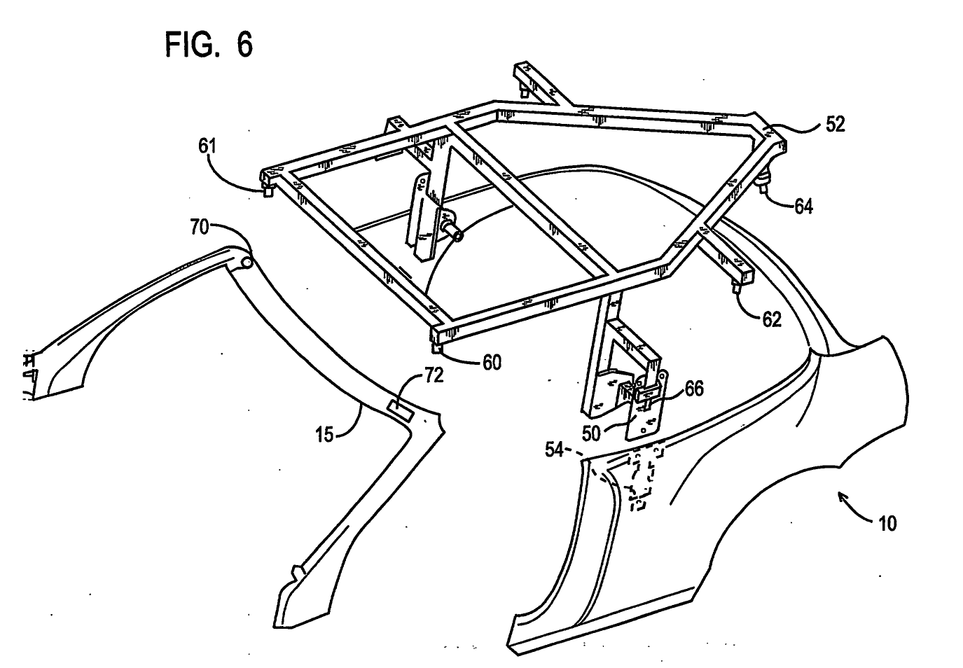

FIG. 6 illustrates the same gage but in a perspective view. Here the structure and rigidity built into the spider gage to ensure accurate placement of the bracket is evident. To accurately locate the bracket 50 in the body 10, a forward corner 61 of the spider gage 52 is engaged with a hole 70 in the windshield header structure 15 to provide fore-aft and cross-car location. The other front corner 60 of the spider gage 52 is engaged with a cross-car slot 72 at the opposite corner of the windshield header 15 which allows the gage to pivot slightly around hole 70 to accommodate some variation in vehicle build. Additional features at 62, 64 and 66 on the gage pick up body registration points to further locate the adapter bracket 50 in the up-down plane.

The process to install the adapter brackets 50 on both sides of the vehicle in the area of the rear wheelwells involves the adapter brackets 50 being loaded onto each side of the spider gage 52 using pins (63 in FIG. 5A) which engage with holes in the adapter bracket 50. The spider gage is then robotically engaged with the aforementioned registration features in the vehicle body when the body arrives at the bracket installation station. The spider gage is lowered into position and locates and installs the bracket 50 to the body of the vehicle at 54 either by welding or bolting the bracket in its correct position and orientation for the roof system intended for that specific vehicle body at the demand of the sequenced part delivery system for that assembly line. The spider gage is equipped with hydraulic side action (57 in FIG. 3) that forces the bracket into contact with the vehicle body. Separate welding or bolting robots, or manual assembly may be used to secure the bracket in position to the body. The spider gage then retracts the pins holding the adapter brackets via hydraulic side action and is robotically removed from the body of the vehicle to be used for installation of brackets on the next vehicle.

In an alternate embodiment, the spider gage may locate the adapter bracket and while in that position a robot or other device may mill slots or drill holes in both the body and the bracket to locate the adapter bracket. Alternatively, the spider gage or another robot may be used to weld or bolt the adapter bracket in place while it is being held by the gage.

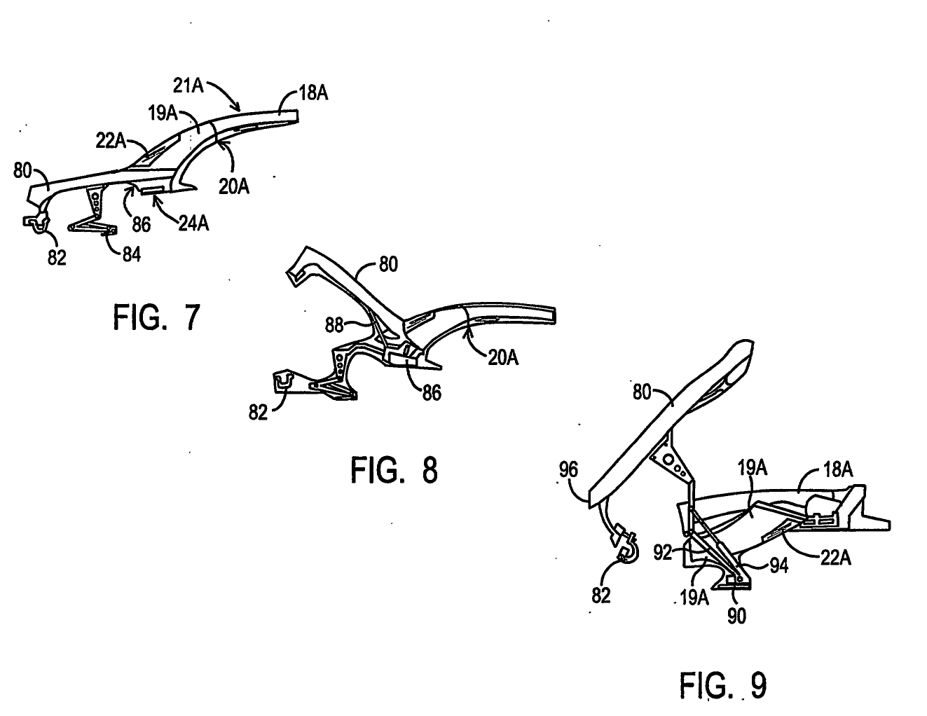

Turning to FIGS. 7, 8 and 9, the provision for storing either the hard or soft top convertible roof system in the trunk of the vehicle is illustrated.

FIG. 7 is a side view of the vehicle of FIG. 1 with the side panels removed and a retractable hardtop roof system 21A installed according to the present invention. The roof system 21A comprises a forward hard panel portion 18A which is hingedly connected at 20A to a rear hard panel portion 19A and rear window 22A. The roof system attachment bracket 24A attaches to the universal adapter bracket (not shown) on the vehicle body. Also shown in FIG. 7 are the vehicle rear deck (trunk) lid 80, the trunk lid latch mechanism 82 and two hinging mechanisms 84 and 86 to allow the trunk to hinge or pivot at the front of the lid for normal trunk access or for the lid to hinge or pivot at the rear to allow the convertible hard or soft top to be retracted and stored in the trunk of the vehicle.

FIG. 8 illustrates how normal use of the vehicle trunk area is achieved, as the rear deck lid is unlatched at 82 and allowed to swing open from the rear of the vehicle by hinging or pivoting around a mechanism 86 located near the front of the rear deck lid 80. The rear deck lid is held open by a gas cylinder or tension spring mechanism 88.

FIG. 9 illustrates hinging of the rear deck lid around a rearward point to allow the retractable hard top to be folded and stored in the trunk space. In FIG. 9, the rear deck lid 80 opens from its front edge due to the action of an extension mechanism 92 and gas cylinder 94 which force the rear deck lid upward. The latch mechanism 82 retains the rear edge of the rear deck lid and the rear deck lid is hinged around its lower rearmost point at 96 to allow the rear deck lid 80 to raise, allowing space for the retractable top to fold, hinge or slide into the trunk of the vehicle. FIG. 9 illustrates this feature as window 22A and rear hard panel portion 19A can be seen folded under front hard panel portion 18A when they are in a collapsed storage position in the vehicle trunk space. The storage of the retractable top can be actuated by the driver electronically once the front latching mechanisms are unlatched.

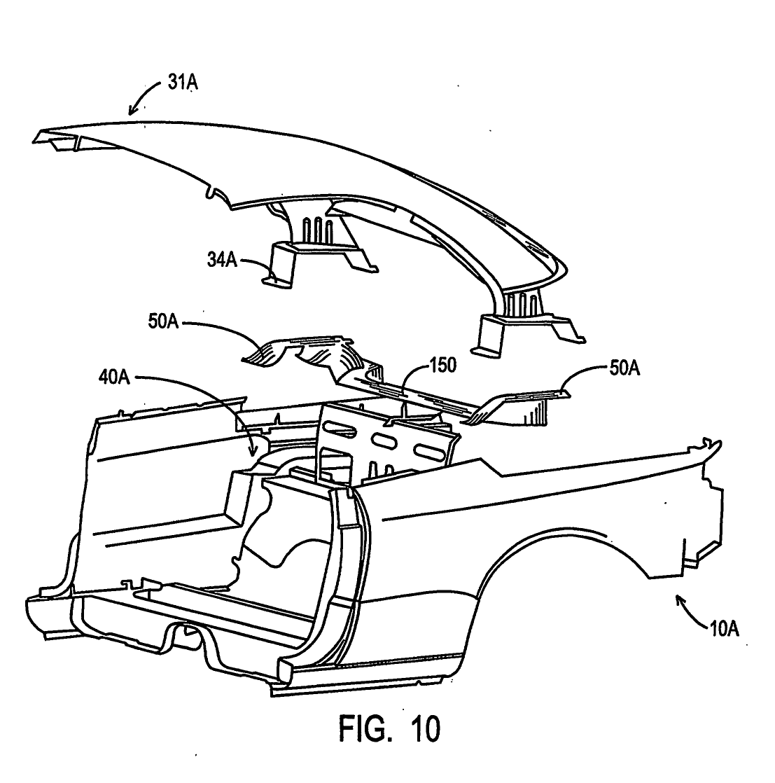

In an alternate embodiment, the present invention comprises a transverse support in the shape of a beam member which may be used to attach the selected roof system to the vehicle body. The transverse support may be attached to the aforementioned adapter brackets before or after they have been located and installed to the vehicle body, thus providing additional structure to the vehicle body in an area just rearward of the rear seats of the vehicle. Subsequently, the selected roof system may be attached to the transverse support. In an alternate embodiment, the roof system may be first assembled to the transverse support, including pivot linkage, power drive unit, etc., and then the transverse support may act as an assembly fixture as well as transport means, subsequently functioning to connect the roof system to the car body through the adapter brackets. FIG. 10-15 illustrates these embodiments.

In FIG. 10, the rear half of a vehicle body 10A is shown sectioned cross-car at about the midpoint of the vehicle. In this embodiment, the adapter brackets 50A are integrated into a transverse support structure 150. The adapter brackets 50A are oriented essentially horizontally and mount to the body in the area of the wheelwells 40A of the vehicle body 10A. Also shown in FIG. 10 is a rigid hard roof system 31A which may subsequently be attached to the adapter brackets 50A on the transverse support 150 in the vehicle body 10A.

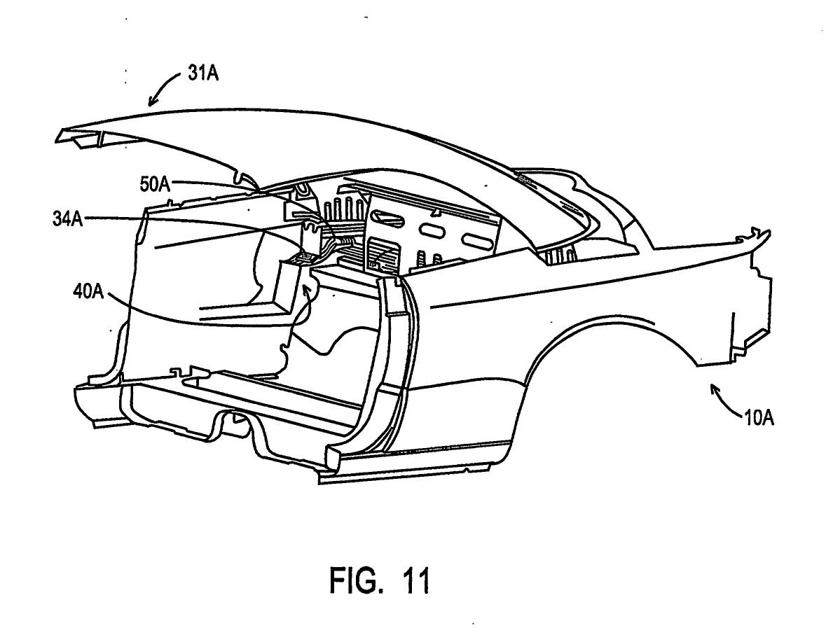

FIG. 11 is an additional view showing the installation of the rigid hard roof system 31A into the vehicle body 10A wherein the adapter brackets 50A are now located and attached to the vehicle body 10A in the area of the rear wheelwell 40A and subsequently the rigid roof system 31A is attached through attachment brackets 34A to the adapter brackets 50A.

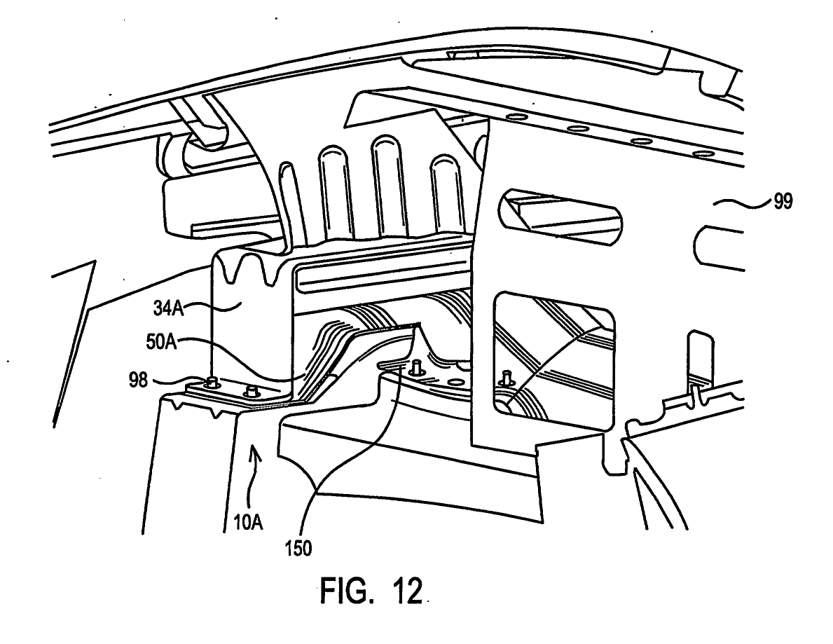

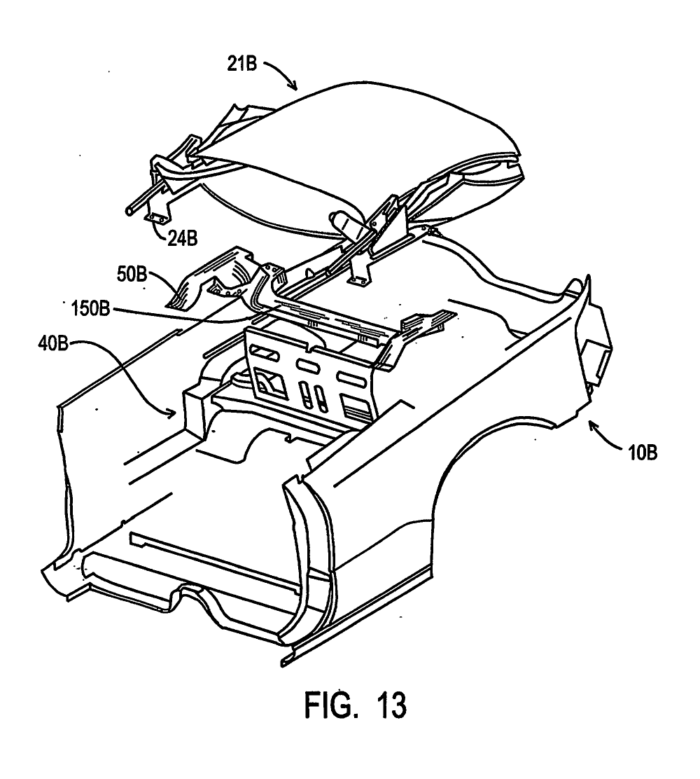

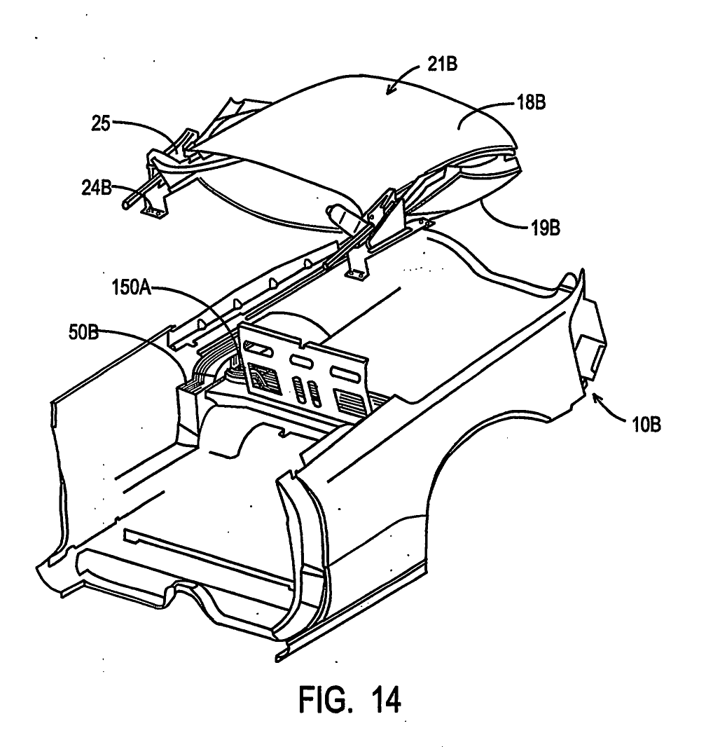

FIG. 12 is an enlarged view of this area of attachment, viewed from underneath the rigid roof system. In this view, adapter bracket 50A is located on and attached to sheet metal body 10A using bolts 98. In underlying relationship, the attachment brackets 34A are then attached using the same bolts 98. Alternatively, attachment of the respective bracketry may be by welding, adhesive or other means known to those skilled in the art. In this embodiment, the transverse support 150 is shown attached to the vehicle body 10A in an area rearward of the rear seat back 99 to provide additional structural support to the vehicle body. Subsequently, the rigid hard roof system may be attached at the roof header (not shown) and other area in the vehicle body to meet vehicle structural and safety requirements. FIG. 13-15 illustrate a similar process for installing a convertible top roof system of the present invention into the same vehicle body, in this case the roof system is a retractable hard top. In FIG. 13 a transverse support 150A includes adapter brackets 50B which conform to an area of the vehicle body 10B in the area of the rear wheelwells. The adapter brackets 50B may contain unique features such as slots, recesses or a hole pattern that distinguish one roof system from another such any of the aforementioned roof systems may be accurately installed in the vehicle body. A retractable hardtop roof system 21B is shown in a position above the vehicle body 10B and adapter brackets 50B, ready to be installed. FIG. 14 is a view showing the transverse beam 150A including adapter brackets 50B after installation and attachment using a spider gage (not shown) into rear wheelwells of the vehicle body 10B. In this view, the retractable hardtop roof system 21B is in a collapsed condition, ready for storage in the trunk area of the vehicle body 10B and comprises a forward hard panel portion 18B, a rear hard panel portion 19B and a rear window (not visible). Attachment bracketry 24B and pivot and linkage mechanism 25 for expanding the roof system to cover the passenger area of the vehicle body 10B is also shown.

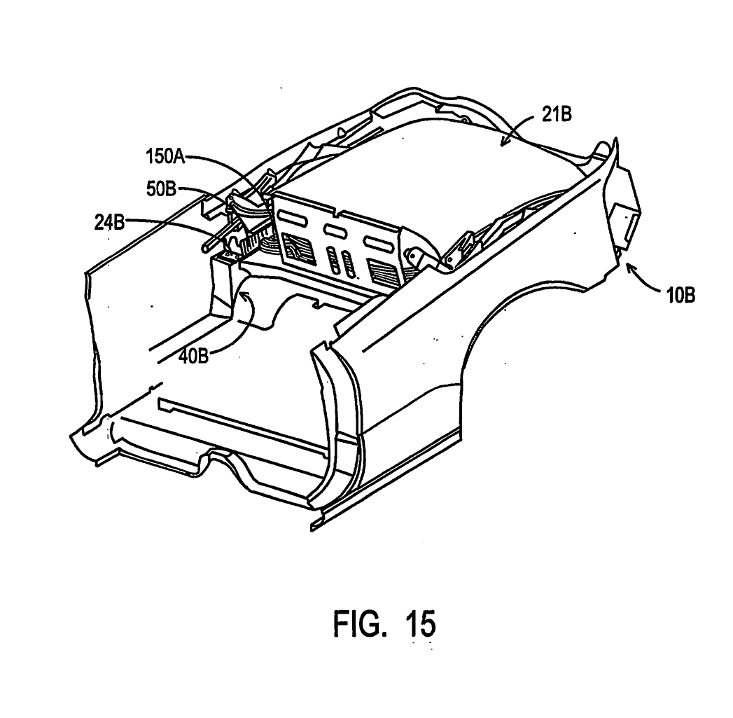

FIG. 15 is a view showing the convertible top, in this case a retractable hardtop 21B, stored in the trunk area of the vehicle behind the rear wheelwell area 40B and installed in overlying relationship to the adapter brackets 50B and transverse support 150A using attachment brackets 24B.

Thus, it can be appreciated that the present invention provides an apparatus and method for installing any one of a number of types of roof systems into a common vehicle body through the use of a universal adapter structure which is preferably located quite accurately in a vehicle body using a spider gage. An alternate embodiment includes a transverse support member which may be used to join the adapter brackets and provide additional structure to the vehicle body and roof system. The advantage of this invention over the prior methods of assembling convertible roof systems become clear when the detailed description is taken in combination with the appended drawings. In addition, it is noted that the various features in all of the illustrations may be properly exchanged between each embodiment as may be appropriate in the context of the present invention.

The description and drawings illustratively set forth the presently preferred invention embodiment. We intend the description and drawings to describe this embodiment and not to limit the scope of the invention. Obviously, it is possible to modify these embodiments while remaining within the scope of the following claims. Therefore, within the scope of the claims, one may practice the invention otherwise than as the description and drawings specifically show and describe.

What is claimed is:

1. An apparatus for use in a motor vehicle having a roof system, said motor vehicle further having a body with a passenger compartment and a trunk space, said apparatus comprising:
a roof system comprising any one of a rigid panel hardtop,
a retractable hardtop moveable from an extended position disposed above said passenger compartment to a retracted position, or a soft convertible top movable from an extended position disposed above said passenger compartment to a retracted position, wherein any one of said rigid panel hardtop, retractable hardtop or convertible soft top includes an attachment bracket
a transverse support beam having a first end and a second end, said support beam carrying any one of said rigid panel top, said retractable hardtop or said soft convertible top, wherein said first end and said second end include universal adapter brackets,
wherein said universal adapter brackets are connected to said attachment brackets and to the vehicle body.

2. The apparatus of claim 1 including a dual hinged rear deck lid covering said trunk space wherein said rear deck lid is capable of pivoting to allow retraction of any one of said retractable hardtop or said soft convertible top into said trunk space for storage.

3. The apparatus of claim 1 wherein said universal adapter brackets comprise metal plates containing a series of holes or slots or features that align with said first end and said second end of said transverse beam.

4. The universal adapter brackets of claim 1 wherein said brackets are attached to said vehicle body by any one of welding, riveting, bolting or adhesive attachment.

5. An apparatus for use in a motor vehicle having a roof system, said motor vehicle further having a body with a passenger compartment and a trunk space, said apparatus comprising:
a roof system comprising any one of a rigid panel hardtop,
a retractable hardtop moveable from an extended position disposed above said passenger compartment to a retracted position, or a soft convertible top movable from an extended position disposed above said passenger compartment to a retracted position, wherein any one of said rigid panel hardtop, retractable hardtop or convertible soft top includes an attachment bracket
a transverse support beam having a first end and a second end, said support beam carrying any one of said rigid panel top, said retractable hardtop or said soft convertible top, wherein said first end and said second end include universal adapter brackets,
wherein said universal adapter brackets are connected to said attachment brackets.

6. The apparatus of claim 5 wherein said universal adapter brackets comprise metal plates containing a series of holes or slots or features that align with said first end and said second end of said transverse beam.

7. The universal adapter brackets of claim 5 wherein said brackets are attached to said vehicle body by any one of welding, riveting, bolting or adhesive attachment.

8. The apparatus of claim 5 wherein said transverse support beam is connected to the vehicle body.

9. A motor vehicle having a roof system, said motor vehicle further having a passenger compartment and a trunk space, said motor vehicle comprising:
a single body capable of accepting a roof system comprising any one of a rigid panel hardtop, a retractable hardtop or a soft convertible top, and
universal adapter brackets attached to said body to locate and attach said any one of said rigid panel hardtop, said retractable hardtop or said soft convertible top roof system.

10. A motor vehicle roof system for use in an automotive vehicle having a passenger compartment and a storage compartment, said roof system comprising:
a transverse support beam structure having a first end and a second end,
one of (i) a rigid panel roof structure fastened to said vehicle or (ii) a retractable hardtop structure said retractable hardtop structure comprising a series of hingedly or slidably engaged panels, said retractable hardtop being movable between an extended position covering the passenger compartment and a retracted position for storage in said storage compartment, or (iii) a soft convertible top structure comprising a fabric covering and folding mechanism, said soft convertible top being movable between an extended position covering said passenger compartment and a retracted position for storage in said storage compartment,
wherein said transverse beam structure connects to one of said rigid panel roof, retractable hardtop or soft convertible top to provide for assembly of one of said rigid panel roof, retractable hardtop or soft convertible top upon said beam,
wherein said transverse support structure provides a handling and transport aid for said roof system, and
wherein said transverse support provides attachment at said first end and said second end within said vehicle.

11. The transverse support of claim 10, wherein said transverse support provides structural support to the vehicle.

12. The transverse support of claim 10, wherein said transverse support includes a power unit for extending and retracting said retractable hardtop or said soft convertible top.

13. An apparatus for storing a retractable roof system for a vehicle having a trunk and a passenger compartment, said apparatus comprising:
a trunk lid having a front edge and a rear edge,
a pivot mechanism located near said trunk lid rear edge to allow said trunk lid front edge to pivot from a closed position to an extended position wherein said retractable roof system can be retracted from an open position covering the passenger compartment of a vehicle to a retracted position in said trunk, and
a pivot mechanism located near said trunk lid front edge to allow said trunk lid to pivot around said front edge from a closed position to an open position to allow access to said trunk.

14. A method of installing a roof system on a motor vehicle body comprising the steps of;
providing a common vehicle body having dimensional registration points, selecting a roof system to be installed on said body, wherein said roof system comprises one of a rigid hardtop, a retractable hardtop or a soft convertible top, wherein said roof system includes attachment brackets with mating features,
providing adapter brackets wherein said adapter brackets contain mating features that correspond to mating features in said attachment brackets,
providing a spider gage, wherein said spider gage is located in said vehicle via said dimensional registration points, wherein said spider gage includes said adapter brackets,
locating said adapter brackets mounted on said spider gage to said vehicle body,
attaching said adapter brackets to said vehicle body,
removing said spider gage,
installing one of said rigid hardtop, retractable hardtop or soft convertible top on to said adapter brackets in said vehicle body by matching the mating features in said adapter brackets to the mating features in said attachment bracket,
attaching said selected roof said system to said vehicle body.
